(19) United States
(12) Patent Application Publication
(10) Pub. No.: US 2010/0261389 A1
(43) Pub. Date: Oct. 14, 2010

(54) CONNECTION APPARATUS

(75) Inventors: Tetsuharu OGINO, Miyagi-ken (JP); Tetsuya ISHIMORI, Miyagi-ken (JP)

Correspondence Address: Beyer Law Group LLP, P.O. BOX 1687, Cupertino, CA, 95015-1687, US

(73) Assignee: ALPS ELECTRIC CO., LTD., Tokyo (JP)

(21) Appl. No.: 12/750,593

(22) Filed: Mar. 30, 2010

(30) Foreign Application Priority Data
Apr. 10, 2009 (JP) 2009-095701

(51) Int. Cl. H01R 13/40

(52) U.S. Cl. 439/733.1

(57) ABSTRACT

There is provided a connection apparatus for an electronic component which is able to conveniently and rapidly perform attachment and detachment of a relay board without touching elastic contact points. The relay board is integrally formed by stacking a first cover, a relay sheet and a second cover. The relay board may be handled by picking up holding target sections which are formed on opposite end parts of the first cover without touching spiral contacts (elastic contact points). Further, when hold members are pivoted to be set in an open state by manipulating manipulation sections, the relay board may be mounted on a bottom surface of an mounting section, and when the hold members are pivoted to return to a hold state, the holding target sections are held by claw sections. Accordingly, the relay board can be conveniently and rapidly mounted and detached.

### CROSS REFERENCE TO RELATED APPLICATION

The present invention relates to a connection apparatus. The present application claims priority on the basis of Japanese Patent Application No. 2009-095701, filed on Apr. 10, 2009, contents of which will be incorporated by reference herein.

### BACKGROUND

1. Technical Field

The present invention relates to a connection apparatus for checking electronic components such as semiconductor elements, and more particularly, to a connection apparatus for electronic components which is capable of exchanging a relay board having a plurality of elastic contact points which is connected to terminals of the electronic component.

2. Related Art

In general, in a manufacturing process of a variety of electronic components such as an IC (Integrated Circuit) or LSI (Large Scale Integration, IC having integrated elements of 1000 to 10000), a conduction test or the like is performed by connecting the electronic components to a test circuit through a socket (connection apparatus) for testing, and thus, defective electronic components are prevented from being mounted on a packaging circuit.

A socket for burnin testing is disclosed in the Japanese Unexamined Patent Application Publication No. 2007-200803. In the socket disclosed in the Japanese Unexamined Patent Application Publication No. 2007-200803, a guide member 30 is mounted on a lower surface of a mounting section 11, and a relay board 20 is detachably mounted on a lower surface thereof. A plurality of spiral contacts 24A and 24B is arranged on opposite surfaces of the relay board 20, and a plurality of small holes 31 is formed in the guide member 30. The upper spiral contact 24A is inserted into the small hole 31 which is formed in the guide member 30. If an electronic component 1 is mounted on the mounting section 11, a spherical contact (external connection terminal) 2a which is mounted on a lower surface of the electronic component 1 is guided to the small hole 31 of the guide member 30, to thereby perform connection with the spiral contact 24A.

Further, in the state that the electronic component 1 is mounted in the socket, the burnin test is performed, and electronic components which are recognized as defective products is extracted from the socket and discarded, and only good quality products are brought to the market. With such a socket, it is possible to perform the same test with respect to the plurality of electronic components.

Since the relay board 20 is a consumable article, it is necessary to exchange the old relay board 20 each time it has been used for several hundreds to several thousands of hours with a new relay board 20.

In the socket disclosed in the Japanese Unexamined Patent Application Publication No. 2007-200803, a boss 10a which is mounted on a lower surface of the socket 10 is inserted with allowance into a positioning hole 27 which is formed in a corner of a sheet 21, and a first locking section 10a1 which is formed in a front end part of the boss 10a supports an inner edge of the positioning hole 27, so that the relay board 20 is mounted on the lower surface of the socket 10.

Here, the diameter of the positioning hole 27 is larger than that of the boss 10a and is slightly smaller than that of the first locking section 10a1. Accordingly, in the exchanging process of the relay board 20, it is necessary to forcibly insert the first locking section 10a1 in the positioning hole 27, and thus, its attachment and detachment become difficult.

Further, when attaching and detaching the relay board 20, a user may be in direct contact with the spiral contacts 24A and 24B which are mounted in the relay board 20, to thereby cause deformation or damage in the spiral contacts 24A and 24B.

In addition, when inserting the first locking section 10a1 in the positioning hole 27, the positioning hole 27 may be excessively extended, and thus, support of the relay board 20 by means of the first locking section 10a1 may become insufficient.

### SUMMARY

An advantage of some aspects of the invention is that it provides a connection apparatus for an electronic component which is able to conveniently and rapidly perform attachment and detachment of a relay board without touching elastic contact points.

Further, the invention provides a connection apparatus for an electronic component which is able to firmly support the relay board.

According to an embodiment of the invention, there is provided a connection apparatus including: a base which is formed on a bottom surface thereof with an mounting section to which an electronic component having a plurality of external connection terminals is mounted; and a relay board which has an elastic contact point which is connected to the external connection terminal, and is mounted in a position opposite to the mounting section on the base, wherein a holding target section which protrudes in a side direction is mounted in the relay board, and a hold member which attachably and detachably holds the holding target section is mounted in a side part of the base.

Accordingly, the relay board having the elastic contact points may be conveniently and rapidly exchanged. Further, since direct contact with the elastic contact points is prevented, elastic contact points may be protected from being deformed or damaged.

For example, a claw section for locking the holding target section may be formed in the hold member, the hold members may be mounted on opposite sides of the mounting section to be able to pivot, respectively, and each hold member may be biased in a direction where the claw sections come closer to each other.

The relay board may be formed by assembling a relay sheet in which a plurality of elastic contact points is formed, a first cover which is formed with a plurality of small holes and is arranged opposite to one surface of the relay sheet, and a second cover which is formed with a plurality of small holes and is arranged opposite to the other surface of the relay sheet, and the holding target section may be respectively mounted on opposite sides of the first cover.

In this embodiment, the first cover or the second cover are configured so that the hand of a user or the like can be prevented from being in direct contact with the plurality of elastic contact points which is formed on the relay sheet, and connection between the external connection terminal and the elastic contact point with respect to the electronic component can be secured.

In between at least one of the first cover and the second cover and the relay sheet may be biased by a biasing member, the biasing member may be a plate spring in which a fixing end side thereof is fixed to the relay sheet and a free end part thereof extends toward the first cover or the second cover, and a protrusion section which is mounted in a front end of the free end side may be inserted into an elongated hole which is formed in the first cover or the second cover.

In this embodiment, horizontal positioning of the first cover, the relay sheet and the second cover can be performed with high accuracy. Each small hole of the first cover, each elastic contact point of the relay sheet and each small hole of the first cover may overlap.

A guide member formed with a plurality of small holes which guides the external connection terminals to the elastic contact points may be mounted between the mounting section and the relay board, and a front end of the protrusion section may be inserted into an elongated hole which is formed in the guide member.

In this embodiment, the relay board may be positioned with respect to the bottom surface of the base with high accuracy, each small hole of the guide member, and each small hole of the first cover and each elastic contact point of the relay sheet may correspond to each other in a height direction.

A locking recess section may be formed in the first cover and a locking section may be formed in the second cover, and as the locking section and the locking recess section are locked, the relay board may be held between the first cover and the second cover.

With such a configuration, the relay board may be conveniently assembled.

Further, the elastic contact points may be formed of the spiral contacts.

According to the embodiments of the invention, when exchanging the relay board, attachment and detachment can be performed without touching at least one surface of the relay board, and thus, deformation or damage to the elastic contact points does not occur.

Further, the relay board can be conveniently, rapidly and firmly mounted with respect to the base of the connection apparatus.

### BRIEF DESCRIPTION OF THE DRAWINGS

FIG. 1 is a perspective view illustrating a connection apparatus according to an embodiment of the invention.

FIG. 2 is a perspective view illustrating a connection apparatus for electronic components when seen from a bottom side.

FIG. 3 is a sectional view taken along a line III-III in FIG. 1.

FIG. 4 is an exploded perspective view illustrating a first cover, a relay sheet and a second cover.

FIG. 5 is a perspective view illustrating a relay board which is an assembly of the first cover, the relay sheet and the second cover, and a guide member.

FIG. 6 is a partly enlarged sectional view illustrating the relay sheet.

FIG. 7 is a partly enlarged sectional view illustrating a state that the electronic components are mounted to the connection apparatus.

### DESCRIPTION OF EXEMPLARY EMBODIMENTS

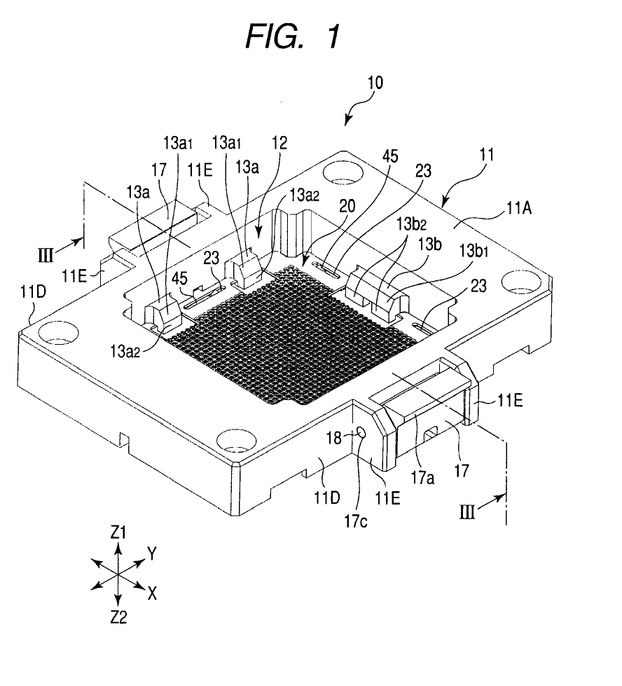

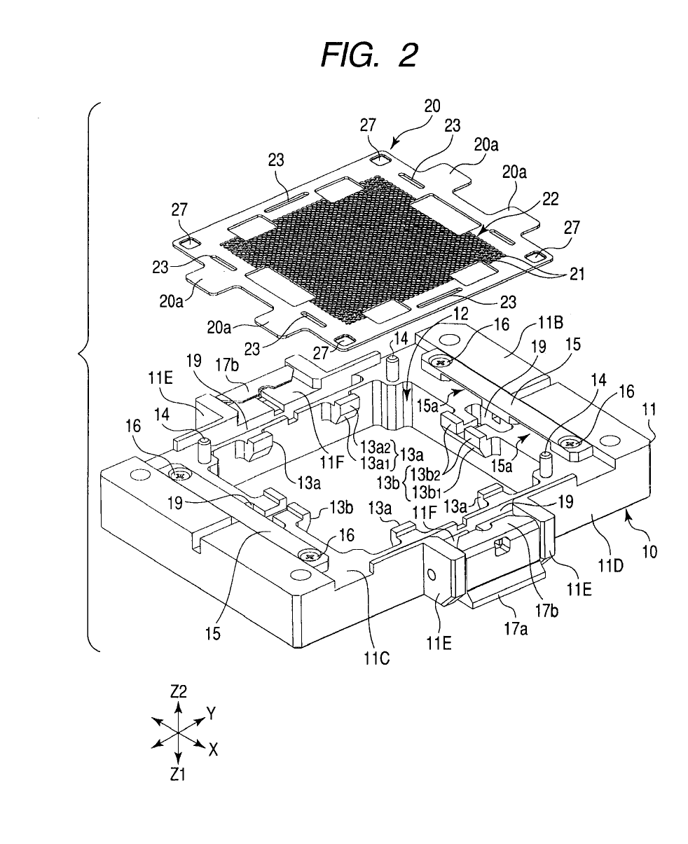

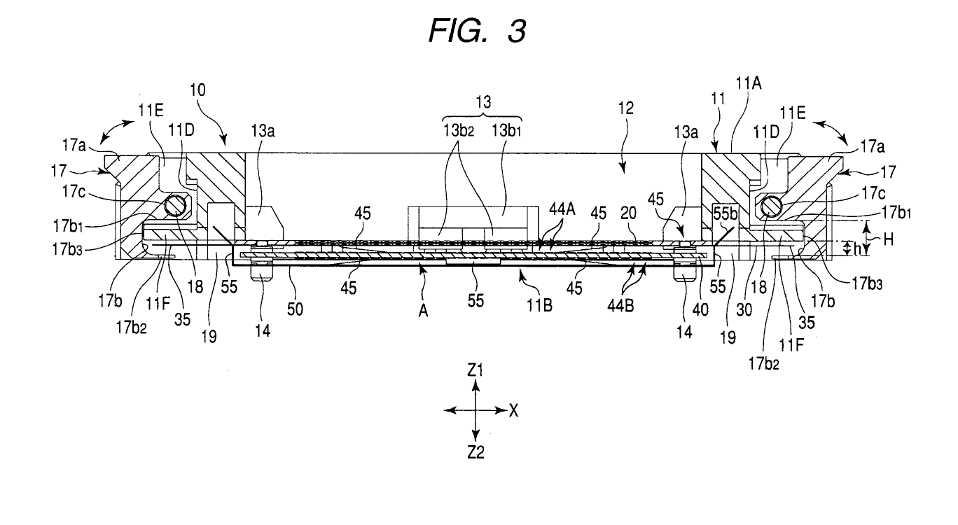

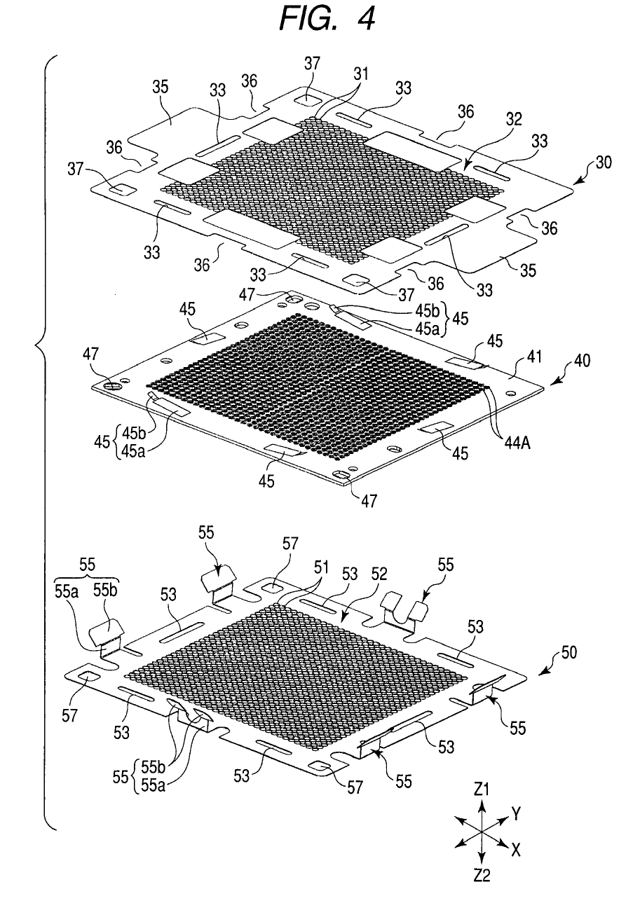

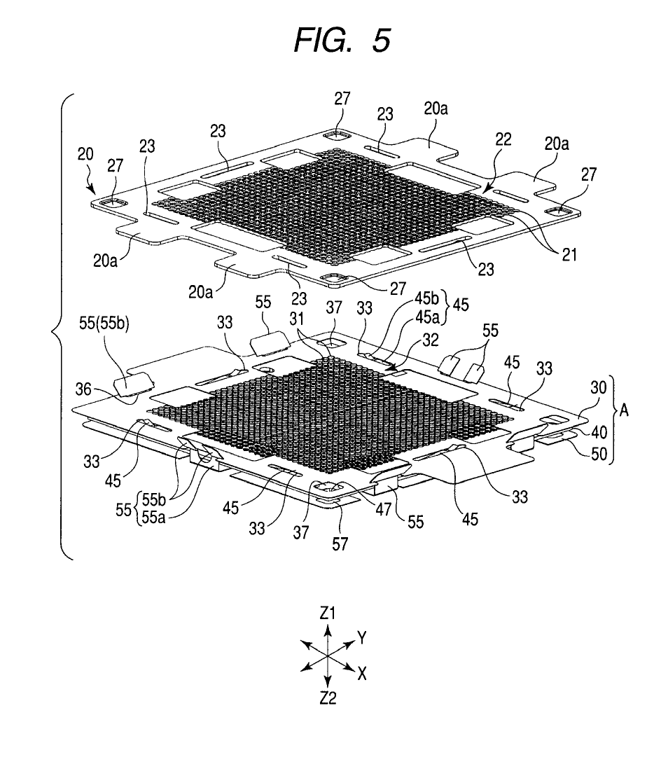

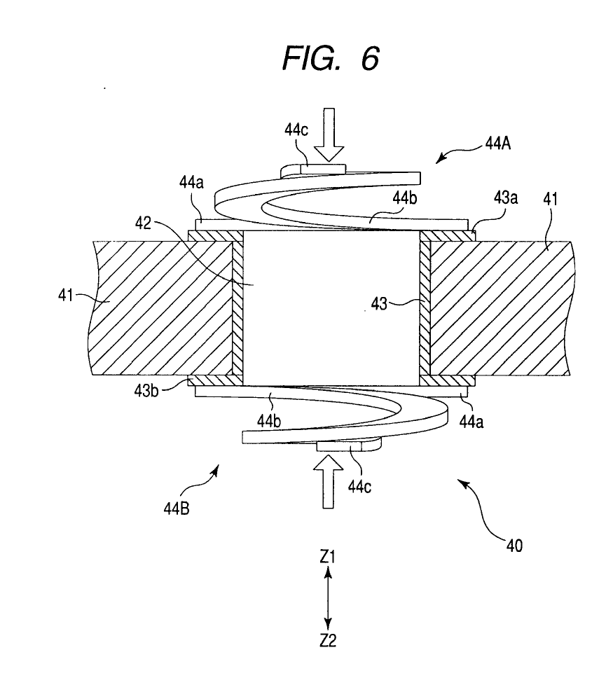

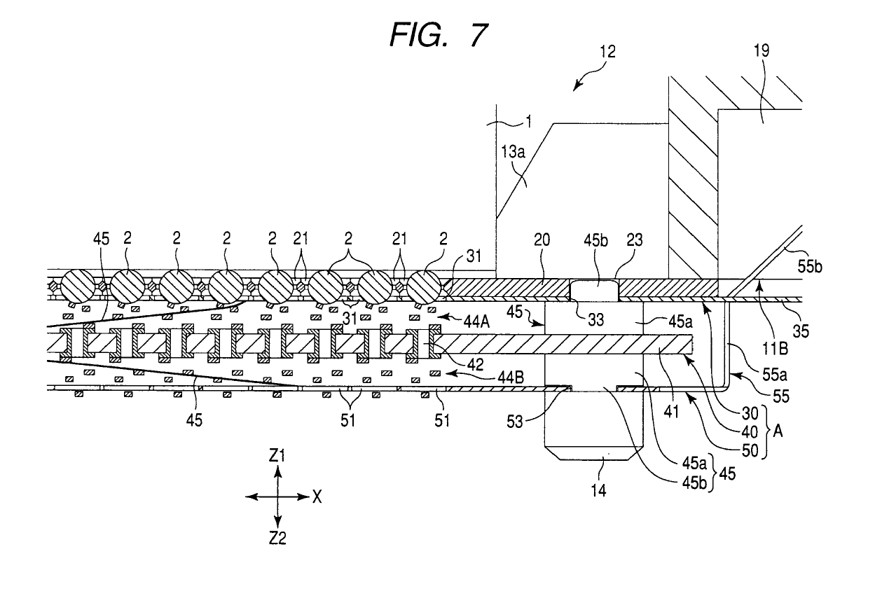

FIG. 1 is a perspective view illustrating a connection apparatus for electronic components according to an embodiment of the invention; and FIG. 2 is a perspective view of the connection apparatus for electronic components when seen from a bottom side. In FIG. 2, the connection apparatus and a guide member are illustrated, but a first cover, a relay sheet and a second cover are omitted. Further, FIG. 3 is a sectional view taken along a line III-III in FIG. 1; FIG. 4 is an exploded perspective view illustrating the first cover, the relay sheet and the second cover; and FIG. 5 is a perspective view illustrating a relay board which is an assembly of the first cover, the relay sheet and the second cover, and a guide member; FIG. 6 is a partly enlarged sectional view illustrating the relay sheet; and FIG. 7 is a partly enlarged sectional view illustrating a state that the electronic components are mounted in the connection apparatus.

A connection apparatus 10 shown in FIG. 1 is an examination connection apparatus 10 which is used when a variety of tests such as a conduction test with respect to a variety of electronic components such as IC or LSI.

The connection apparatus 10 includes a base 11 which is formed of a resin material having insulation properties and an approximately rectangular shape. A mounting section 12 is formed in a center area of the base 11. The mounting section 12 is provided as a through hole having an approximately square shape which goes through in a plate thickness direction. An electronic component 1 for testing is mounted inside of the mounting section 12.

Positioning protrusion sections 13a and 13b for positioning the electronic component 1 are formed on four inner walls for forming the mounting section 12, respectively. In this embodiment, two positioning protrusion sections 13a and 13a are formed on each of the pair of inner walls which is opposite to each other in an X direction in the figure, and one positioning protrusion section 13b is formed on each of the pair of inner walls which is opposite to each other in an Y direction in the figure.

The respective positioning protrusion sections 13a and 13b have guide sections 13a1 and 13b1 which are formed of an inclined surface, and positioning sections 13a2 and 13b2 which are formed of a vertical surface, respectively. The electronic component 1 which is mounted in the mounting section 12 from an upper direction in the figure is centered by the respective guide sections 13a1 and 13b1, and is correctly positioned in the mounting section 12 by the opposite positioning sections 13a2 and 13a2 and the opposite positioning sections 13b2 and 13b2.

As shown in FIG. 1, a pair of wall sections 11E and 11E which protrudes at a predetermined interval is formed on side surfaces 11D and 11D of the base 11 in the X direction, respectively. Rotational shafts 18 and 18 are mounted on the wall surfaces in which the pairs of wall sections 11E and 11E are opposite to each other, and hold members 17 and 17 which are supported to be able to pivot are mounted in the rotational shafts 18 and 18, respectively.

As shown in FIG. 3, the hold members 17 and 17 which are mounted on left and right sides in the X direction have the same configuration. The hold member 17 includes a manipulation section 17a which is mounted in a side of a surface 11A of the base 11, a hold recess section 17b which is mounted in a side of a bottom surface 11B, and a shaft hole 17c which is mounted between the manipulation section 17a and the hold recess section 17b, which are integrally formed by synthetic resin materials or metallic materials. The rotational shaft 18 is inserted into the shaft hole 17c, and supports the hold member 17 to be able to pivot. The hold recess sections 17b and 17b have facing sections 17b1 and 17b1 in a side of the shaft hole 17c, claw sections 17b2 and 17b2 in a front end part thereof, and side sections 17b3 and 17b3 therebetween. The facing sections 17b1 and 17b1 and the claw sections 17b2 and 17b2 are opposite to each other with a predetermined gap H in a height direction (Z).

Biasing members (not shown) which are formed of a torsion coil spring or the like are mounted in the rotational shafts 18, respectively, and the hold members 17 and 17 are biased in a direction where the claw sections 17b2 and 17b2 come closer to each other. The hold members 17 and 17 are in a hold state when one claw section 17b2 is close to the other claw section 17b2.

As shown in FIG. 3, stopper sections 11F and 11F which horizontally extend in a side direction from the side surfaces 11D and 11D are formed between each pair of wall sections 11E and 11E. Front end parts of the stopper sections 11F and 11F are accommodated in the hold recess sections 17b and 17b, and the front end parts thereof come in contact with the side sections 17b3 and 17b3, to pivot the hold members 17 and 17 so that distance between the one claw section 17b2 and the other claw section 17b2 is restricted from being further decreased.

In the state shown in FIG. 3, if the manipulation sections 17a and 17a are pressed in a direction which the manipulation sections 17a and 17a are close to each other from the opposite sides, the hold members 17 and 17 pivot to be set in an open state that the distance between the one claw section 17b2 and the other claw section 17b2 is increased.

As shown in FIG. 1, a guide member 20 is mounted in a bottom section of the mounting section 12. As shown in FIG. 2, the guide member 20 is a plate member having an approximately square shape, and for example, is formed of synthetic resin or metallic materials having insulation properties. In opposite ends in the Y direction of the guide member 20, two protrusion sections 20a and 20a which protrude from opposite sides, respectively, are integrally formed at a predetermined distance in the X direction.

A small hole area 22 is formed in a center region of the guide member 20. A plurality of small holes 21 which is penetrated in a plate thickness direction is arranged in the small hole area 22 in a matrix formation. The size of each small hole 21 is approximately the same as a diameter of an elastic arm of a spiral contact which will be described later, and has several tens of μm to several hundreds of μm. Pitches between the adjacent small holes 21 in the longitudinal and transverse (XY) directions are within 1 mm.

Elongated holes 23 are formed along respective sides in parallel in an outer region of the small hole area 22 in which the plurality of small holes 21 are formed. Further, holding holes 27, 27, 27 and 27 which penetrate the plate thickness direction are formed in four corners of the guide member 20, respectively. Each small hole 21 is formed to correspond to an external connection terminal 2 such as a spherical contact (BGA) which is formed in a bottom surface of the electronic component 1.

As shown in FIG. 2, an installation recess section 11C is formed on the bottom surface 11B of the base 11, and support columns 14, 14 and 14 which are vertically mounted are formed in three corner sections of the installation recess section 11C, respectively.

In addition, fixing members 15 and 15 are mounted on opposite sides of the installation recess section 11C. Two fixing members 15 have the same configuration, and hold recess sections 15a and 15a which are mounted at a predetermined distance in the X direction are respectively formed on a surface opposite to the installation recess section 11C. The fixing members 15 are fixed on opposite sides of the installation recess section 11C in the Y direction by screws 16 and 16 which are provided in opposite end parts of the X direction.

The guide member 20 inserts the support columns 14, 14, and 14 into the support holes 27, 27 and 27 in the state that the hold member 17 is set to be an open state and the fixing members 15 and 15 are removed, and thus, the guide member 20 is mounted in the state of being positioned in the installation recess section 11C. By installing the fixing members 15 and 15 on the opposite sides of the installation recess section 11C and fastening the corresponding screws 16 and 16, the guide member 20 is fixed on the bottom surface 11B of the base 11, more specifically, in the installation recess section 11C. At this time, the protrusion sections 20a and 20a of the guide member 20 are held by the hold recess sections 15a and 15a which are formed in the fixing member 15. In this way, the guide member 20 may be conveniently, rapidly and effectively changed by removing the fixing members 15 and 15.

As shown in FIGS. 3 to 5, a relay board A, which includes a first cover 30, a relay sheet 40 and a second cover 50, from an upper layer part toward a lower layer part, is mounted under (a side of Z2) the guide member 20.

The first cover 30 and the second cover 50 each are formed of a sheet shaped member having excellent insulation properties such as a polyimide film.

As shown in FIG. 4, holding target sections 35 and 35 which protrude in a direction X1 and a direction X2 in the figure are mounted on opposite sides of the highest first cover 30 in the Y direction. A small hole area 32 is formed in a center region of the first cover 30, and a plurality of small holes 31 is arranged in the small hole area 32 in a matrix formation. Each small hole 31 is formed to correspond to the external connection terminal such as a spherical contact (BGA) which is formed in the bottom surface of the electronic component 1 and each small hole 21 which is formed in the guide member 20.

Further, a plurality of elongated holes 33 which extends in parallel with respective sides is formed on an outer side of the small hole area 32. A position of each elongated hole 33 coincides with each elongated hole 23 which is formed in the guide member 20. In addition, holding holes 37, 37 and 37 are formed in three corner sections of the first cover 30, and locking recess sections 36 are formed in predetermined locations of four sides.

A configuration of the second cover 50 which is the lowest layer is approximately the same as that of the first cover 30. That is, the second cover 50 includes a plurality of small holes 51 in a small hole area 52, and a plurality of elongated holes 53 which extends in parallel along respective sides on an outer side of the small hole area 52. Further, holding holes 57, 57 and 57 are formed in three corner sections of the second cover 50.

Here, instead of the holding target sections 35 and 35 which are mounted in the first cover 30, a plurality of locking sections 55 is formed in the second cover 50.

As shown in FIG. 4, each locking section 55 has an extension section 55a which extends in each of the X direction and the Y direction from an end part of the sheet, and a wide section 55b which is formed in a front end part thereof. The extension section 55a is vertically bent from an edge part of the second cover 50, and the wide part 55b is bent in the state of being inclined with respect to the extension section 55a.

The relay sheet 40 has the same configuration as the relay board in the related art. That is, the relay sheet 40 includes a base material which is formed of an insulation sheet 41 made of resin such as polyimide. A plurality of through holes 42 is formed through the sheet 41 in a matrix formation, and spiral contacts 44A and 44B are mounted above and under the respective through holes 42, respectively. The arrangement pitches of the plurality of through holes 42 which is arranged in the longitudinal and transverse directions depends on the arrangement of the external connection terminal 2 which is formed on the bottom surface of the electronic component 1 (see FIG. 6).

Next, the spiral contacts 44A and 44B will be described.

As shown in FIG. 6, a conductive section 43 which is plated with copper is formed on an inner circumferential surface of each of the through holes 42, and connection sections 43a and 43b which are exposed on a front surface and a rear surface of the sheet 41 are formed in an upper end part (end part in a direction Z1 in the figure) and a lower end part (end part in a direction Z2 in the figure) of the conductive section 43. The connection section 43a of the upper end part and the connection section 43a of the lower end part are conductively connected through the conductive section 43.

The spiral contact 44A which serves as an elastic contact point is formed on an upper side of the through hole 42, and the spiral contact 44B is formed on a lower side of the through hole 42, so as to cover opposite opening end parts of the through hole 42.

The spiral contact 44A and 44B are formed by plate-processing nickel or the like on a surface of conductive material such as copper, to thereby achieve excellent conductivity and elasticity as a whole.

The spiral contact 44A and the spiral contact 44B have the same configuration. A base section 44a is formed on an outer circumferential side of each of the spiral contacts 44A and 44B. Further, the base section 44a of the spiral contact 44A is connected to an upper connecting section 43a, and the base section 44a of the spiral contact 44B is connected to a lower connecting section 43b. Accordingly, the spiral contact 44A and the spiral contact 44B are conductively connected to each other through the conductive section 43.

As the spiral contacts 44A and 44B are directed from a winding starting point 44b which is formed in a side of the base section 44a toward a winding ending point 44c of a front end side, the spiral contacts 44A and 44B extend in a spiral winding shape, and the winding ending point 44c is positioned in approximately a center of the through hole 42. Further, as the spiral contacts 44A and 44B are directed from the winding starting point 44b toward the winding ending point 44c, the spiral contacts 44A and 44B are formed of a protrusion shape in a three-dimensional manner so as to gradually move away from the sheet 41. Accordingly, the spiral contacts 44A and 44B are in an elastically deformable state vertically (in a Z1-Z2 direction) in opposite opening end parts of the through hole 42.

As shown in FIG. 4, the holding holes 47, 47 and 47 are formed in three corners of the relay sheet 40.

As shown in FIG. 4, on a front surface of the sheet 41 which forms the relay sheet 40, a plurality of plate springs (biasing members) 45 is mounted in an outer side of a region in which the plurality of spiral contacts 44A is formed. Similarly, on a rear surface of the sheet 41, a plurality of plate springs 45 (biasing members) is mounted in an outer side of a region in which the plurality of spring contacts 44B is formed (see FIGS. 3 and 7).

Each plate spring 45 is formed of a thin conductive metal in a belt-like shape, and includes an elastic section 45a on a base end side thereof and a protrusion section 45b having a width smaller than the elastic section 45a on a front end side thereof. Each plate spring 45 is formed in a balanced state that a lengthwise direction thereof is parallel along each side of the sheet 41. Further, in each plate spring 45, a base end side (fixing end part) of the elastic section 45a is fixed on a surface of the sheet 41, and a front end part in which the protrusion section 45b is mounted is formed as a free end which is raised in an inclined shape toward an upper direction (Z1) in the figure from the sheet 41.

The plate spring 45 may be formed, for example, by performing nickel plating which applies elasticity on a surface of a copper plate, and in this case, may be simultaneously formed in the same process as the spiral contacts 44A and 44B. Accordingly, the plate spring 45 may be formed on the sheet 41 with high accuracy as the same as the spiral contacts 44A and 44B.

Next, assembly of the relay board A which includes the first cover, the relay sheet and the second cover will be described.

As shown in FIGS. 4 and 5, the relay board A is assembled by placing the relay sheet 40 on the second cover 50, and by placing the first cover 30 on the relay sheet 40.

In this assembling process, the holding holes 37, 37 and 37 of the first cover 30, the holding holes 47, 47 and 47 of the relay sheet 40 and the holding holes 57, 57 and 57 of the second cover 50 are all set to be in an overlapping state.

At this time, on an upper part side of the relay sheet 40, the protrusion section 45b of each plate spring 45 which is formed on the upper surface of the relay sheet 40 is inserted into each elongated hole 33 which is formed in the first cover 30. Similarly, on a lower part side of the relay sheet 40, the protrusion section 45b of each plate spring 45 which is formed on the lower surface of the relay sheet 40 is inserted into each elongated hole 53 which is formed on the second cover 50. Accordingly, the first cover 30, the relay sheet 40 and the second cover 50 are positioned with high accuracy in a horizontal direction (the X direction and the Y direction). At the same time, due to the elasticity of each plate spring 45, an elastic force is applied between the first cover 30 and the relay sheet 40, and between the relay sheet 40 and the second cover 50.

Further, the extension section 55a of each locking section 55 which is formed in the second cover 50 is fitted in each locking recess section 36 which is formed in the first cover 30, and the wide section 55b and the locking recess section 36 are locked with each other. In the relay board A shown in this embodiment, locking by the locking sections 55 and the locking recess sections 36 is achieved in six positions. Accordingly, the first cover 30, the second cover 50 and the relay sheet 40 disposed therebetween are not separated from each other, and are integrated in a state that elasticity is applied therebetween.

Accordingly, for example, using a thumb and an index finger, the holding target sections 35 and 35 of the highest first cover 30 may be picked up from opposite sides in the X direction and the relay board A may be simply held. Thus, without touching the plurality of spiral contacts 44A and 44B which is arranged on the upper and lower surfaces of the interior relay sheet 40, the relay board A may be handled.

In addition, the first cover 30, the relay sheet 40 and the second cover 50 are mounted on the bottom surface 11B of the base 11 in the state of the integrated relay board A.

Here, the hold members 17 and 17 are set to an open state, and the relay board A is mounted in the state that the upper surface of the highest first cover 30 is directed to the bottom surface 11B of the base 11 and, more specifically, is directed to the guide member 20. At this time, the support columns 14, 14 and 14 which are mounted on the bottom surface 11B of the base 11 are sequentially inserted into the holding holes 37, 37 and 37 of the first cover 30, the holding holes 47, 47 and 47 of the relay sheet 40 and the holding holes 57, 57 and 57 of the second cover 50, respectively. Accordingly, the relay board A is positioned in the horizontal direction.

When installing the relay board A, as shown in FIGS. 2 and 3, the wide sections 55b of each locking section 55 are respectively inserted into a clearance groove 19 which is formed around the mounting section 12 and, on a side of the bottom surface 11B of the connection apparatus 10.

Next, the front end of the protrusion section 45b of the plate spring 45 which passes through the elongated hole 53 of the second cover 50 is inserted into the elongated hole 23 which is formed in the guide member 20. Thus, with respect to the bottom surface 11B of the base 11, the relay board A may be horizontally positioned with high accuracy.

Further, as shown in FIG. 3, if the holding members 17 and 17 are returned to the holding state, the holding target sections 35 and 35 which are mounted in the first cover 30 are accommodated in a gap h which is formed in a portion where the claw section 17b2 of the hold member 17 and a lower surface of the stopper section 11F are opposite to each other. The gap h is sufficiently large compared with the plate thickness of the holding target sections 35 and 35. Accordingly, the first cover 30, that is, the relay board A may move inside of a space which is formed by the gap h in the height direction (Z).

In addition, the length between the holding target sections 35 and 35 of the opposite sides of the first cover 30 is shorter than an interval between the side section 17b3 of one hold member 17 and the side section 17b3 of the other hold member 17. Further, the length between the holding target sections 35 and 35 of the opposite sides of the first cover 30 is longer than an interval between the claw section 17b2 of one hold member 17 and the claw section 17b2 of the other hold member 17 in the hold state, and is shorter than an interval between the claw section 17b2 of one hold member 17 and the claw section 17b2 of the other hold member 17 in the open state. Accordingly, by returning the hold members 17 and 17 to the hold state, even though the connection apparatus 10 is turned over, the holding target sections 35 and 35 are not separated from the gap h which is formed in a portion where the claw section 17b2 of the hold member 17 and a lower surface of the stopper section 11F are opposite to each other. That is, the relay board A may be firmly held on the side of the bottom surface 11B of the connection apparatus 10.

As shown in FIG. 7, if the relay board A is mounted in the bottom surface 11B of the connection apparatus 10, each small hole 21 of the guide member 20 and each small hole 31 which is formed in the first cover 30 face each other.

Further, on the upper part side of the relay sheet 40, the front end part of the spiral contact 44A which is formed in a three-dimensional manner is set to be inserted into the small hole 31 which is formed in the first cover 30 and the small hole 21 of the guide member 20. Further, on the lower surface side of the relay sheet 40, the front end part of the spiral contact 44B which is formed in a three-dimensional manner is set to be able to be exposed on a lower surface of the second cover 50 through the small hole 51 which is formed in the second cover 50.

Accordingly, as shown in FIG. 7, if the electronic component 1 including a plurality of external connection terminals 2 having a BGA or the like on a bottom surface thereof is mounted and positioned in the mounting section 12 of the connection apparatus 10, each external connection terminal 2 may be in contact with each spiral contact 44A through each small hole 21 of the guide member 20 and each small hole 31 of the first cover 30.

Further, the front end part of the spiral contact 44B which is exposed on the lower surface side of the second cover 50 may be connected with a connection terminal such as a land section which is formed on a substrate (not shown).

In this embodiment, by arranging the first cover 30 on the upper side of the relay sheet 40, and by arranging the second cover 50 on the lower side thereof, the relay board A is integrally formed. That is, it is possible to perform exchange for every integrated relay board A without exchanging just the relay sheet 40. Accordingly, when exchanging the relay board A, it is possible to reduce problems that a user come in direct contact with the plurality of spiral contacts 44A and 44B which is formed in front and rear opposite surfaces of the relay sheet 40. Accordingly, the spiral contacts 44A and 44B may be protected from deformation, damages or the like.

With such a configuration that the holding target sections 35 and 35 which are mounted in the first cover 30 which forms the relay board A are held by one pair of hold members 17 and 17 which is mounted so as to be able to pivot, the relay board A may be conveniently, rapidly and firmly mounted in the connection apparatus 10 compared with the related art.

In the above described embodiment, the first cover 30 and the second cover 50 which protect the spiral contacts 44A and 44B are mounted on the upper surface and the lower surface of the relay sheet 40, the holding target sections 35 and 35 are formed in the first cover 30, and the hold members 17 and 17 protect the holding target sections 35 and 35, but the invention is not limited thereto. That is, holding target sections may be mounted in the relay sheet 40, and the hold members 17 and 17 may hold the holding target sections of the relay sheet 40. In this case, the relay board A is formed of only the relay sheet 40. In this case, by picking up the holding target sections which protrudes on the opposite sides of the relay sheet 40, the relay board A (relay sheet 40) may be handled, and the problem that the spiral contacts 44A and 44B which are formed on upper and lower surfaces are be deformed or damaged may be reduced.

In the above described embodiment, the spiral contacts 44A and 44B are exemplified as the elastic contact points which are formed in the relay sheet 40, but the elastic contact points of the invention is not limited to the spiral contacts, for example, elastic contact points of a so-called POGO pin type or elastic contact points of a plate spring shape may be used.

In addition, in the above described embodiment, the spiral contacts 44A and 44B as the elastic contact points are mounted on the upper or lower opposite surfaces of the relay sheet 40, but the elastic contact points may be mounted on only the upper surface of the relay sheet 40 which is in contact with the external connection terminal 2 of the electronic component 1. In this case, a terminal on the lower surface of the relay sheet 40 may be formed of a bump electrode having a protrusion shape.

It should be understood by those skilled in the art that various modifications, combinations, sub-combinations and alterations may occur depending on design requirements and other factors insofar as they are within the scope of the appended claims of the equivalents thereof.

What is claimed is:

1. A connection apparatus comprising:
a base which is formed on a bottom surface thereof with an mounting section to which an electronic component having a plurality of external connection terminals is mounted; and
a relay board which has an elastic contact point which is connected to the external connection terminal, and is mounted in a position opposite to the mounting section on the base,
wherein a holding target section which protrudes in a side direction is mounted in the relay board, and
a hold member which attachably and detachably holds the holding target section is mounted in a side part of the base.

2. The connection apparatus according to claim 1, wherein a claw section for locking the holding target section is formed in the hold member, the hold members are mounted on opposite sides of the mounting section to be able to pivot, respectively, and each hold member is biased in a direction where the claw sections come closer to each other.

3. The connection apparatus according to claim 1, wherein the relay board is formed by assembling a relay sheet in which a plurality of elastic contact points is formed, a first cover which is formed with a plurality of small holes and is arranged opposite to one surface of the relay sheet, and a second cover which is formed with a plurality of small holes and is arranged opposite to the other surface of the relay sheet, and the holding target section is respectively mounted on opposite sides of the first cover.

4. The connection apparatus according to claim 3, wherein at least one of the first cover and the second cover and the relay sheet is biased by a biasing member to come closer to each other, the biasing member is a plate spring in which a fixing end side thereof is fixed to the relay sheet and a free end part thereof extends toward the first cover or the second cover, and a protrusion section which is mounted in a front end of the free end side is inserted into an elongated hole which is formed in the first cover or the second cover.

5. The connection apparatus according to claim 4, wherein a guide member which is formed with a plurality of small holes which guides the external connection terminals to the elastic contact points is mounted between the mounting section and the relay board, and a front end of the protrusion section is inserted into an elongated hole which is formed in the guide member.

6. The connection apparatus according to claim 3, wherein a locking recess section is formed in the first cover and a locking section is formed in the second cover, and wherein as the locking section and the locking recess section are locked, the relay board is held between the first cover and the second cover.

7. The connection apparatus according to claim 1, wherein each elastic contact point is a spiral contact.
